(19) United States
(12) Patent Application Publication
(10) Pub. No.: US 2012/0330778 A1
(43) Pub. Date: Dec. 27, 2012

(54) PRODUCT COMPARISON AND FEATURE DISCOVERY

(76) Inventor: Garrett Eastham, Austin, TX (US)

(21) Appl. No.: 13/477,831

(22) Filed: May 22, 2012

Related U.S. Application Data
(60) Provisional application No. 61/519,424, filed on May 23, 2011.

(51) Int. Cl. G06Q 30/00

(52) U.S. Cl. 705/26.7; 705/27.2

(57) ABSTRACT

A method of providing a comparison among offerings includes displaying a tabulation of two or more criteria for two or more offerings. An input is received from a user relating to a first one of the criteria in the tabulation. Based on the input received from the user for the first one of the criteria, the tabulation is modified with respect to one or more criteria other than the first one of the criteria.

### PRIORITY CLAIM

This patent application claims priority to U.S. Provisional Patent No. 61/519,424 entitled “Method and Apparatus for Real-Time Document Comparison and Feature Discovery” filed on May 23, 2011, which is incorporated by reference in its entirety as if fully set forth herein.

### BACKGROUND

1. Field

The present invention relates to the technical field of information retrieval systems. More particularly, the present invention relates to systems for presenting recommendations or comparison of products or other items.

2. Description of the Related Art

Shopping for products, services, and other items and offerings by way of computers has become increasingly common in recent years. Some online sellers seek to aid prospective purchasers by providing recommendations for products that may be suitable for the prospective purchaser's needs and preferences.

Many recommendation systems, such as those commonly found powering existing comparison shopping sites or product suggestions on e-commerce sites, may suffer from a need to generate a detailed profile of a user before any meaningful recommendation can take place. Techniques for generating these profiles vary from matching a user to existing customer data or asking a user to submit survey information or rate sample products. Such approaches often create lengthy sign-up processes for new users of a recommendation system. For users who are unfamiliar with the information space, the data collected during this process can be incorrectly biased by lack of domain expertise. Other approaches to recommending products to new users have focused on item-to-item based similarity methods that simply recommend related items not tailored to the particular information retrieval task of the user, or user-to-user based similarity methods such as Collaborative Filtering.

### SUMMARY

Systems and methods for providing real-time recommendations or comparison of products or other items are described. In an embodiment, a method of providing a comparison among two or more offerings includes displaying a tabulation of two or more criteria for two or more offerings. An input is received from a user relating to a first one of the criteria in the tabulation. Based on the input received from the user for the first one of the criteria, the tabulation is modified with respect to one or more criteria other than the first one of the criteria.

In an embodiment, a method of providing a comparison among two or more offerings includes displaying a tabulation of two or more criteria for two or more offerings. An input is received from a user relating to a first one of the criteria in the tabulation. One or more preferences of the user are determined based on the input from the user. The tabulation is modified based on the determined preferences of the user.

In an embodiment, a method of providing a comparison among two or more offerings includes generating a tabulation of two or more criteria for two or more offerings. The tabulation of the two or more criteria is displayed to a user. At least one of the criteria in the tabulation is included based on sponsorship of the criterion or based on sponsorship of a feature associated with the criterion.

In an embodiment, a method of providing a recommendation includes displaying an initial recommendation to a user. The recommendation includes one or more criteria. An input is received from the user relating to one or more of the criteria. The displayed recommendation is updated based on a user preference model for the user. The user preference model is based at least in part on the input received from the user after the initial recommendation is displayed to the user.

### BRIEF DESCRIPTION OF THE DRAWINGS

FIG. 1 is a block diagram illustrating one embodiment of a comparison system;

FIG. 2 is an overview of a web-based or tablet-based comparison interface used to access a recommendation system in one embodiment;

FIG. 3 is a flow diagram illustrating one embodiment of providing a comparison among offerings;

FIG. 4 is an example of a user interacting with the comparison interface and experiencing a visual trade-off analysis of criteria;

FIG. 5 is a visual explanation of one embodiment of a user preference extraction algorithm utilizing feature-to-feature decay to aid in online learning;

FIG. 6 is an overview of one embodiment the described comparison and feature discovery system utilized as an extension of existing search and category results pages in online retail environments;

FIG. 7 is a visual demonstration of the use of feature discovery in natural language search;

FIG. 8 illustrates one embodiment of a comparison and feature discovery interface with images;

FIG. 9 illustrates an embodiment of a comparison and versus landing page;

FIG. 10 illustrates an embodiment of a product page enhanced with a product comparison and feature discovery platform.

FIG. 11 illustrates an embodiment of a category page enhanced with a product comparison and feature discovery platform.

FIG. 12 illustrates one embodiment of a cloud computing system that can be implemented to provide services to consumers or sellers.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

As used herein, a “communications network” refers to a system including one or more communication channels (for example, lines, satellite frequency, or radio waves) interconnecting one or more nodes (for example, servers, routers, computers, or communication devices). Examples of a “communications network” include the internet, a cellular telephone network, a local area network (LAN), or a wide area network (WAN).

As used herein, a “criterion” means any attribute, specification, trait, characteristic, feature, or capacity by which an item or offering can be compared, evaluated, measured, or ranked. A criterion may include the presence or absence of a particular feature or capability. Examples of criteria for a notebook computer system include processor speed, random access memory capacity, memory type, screen size, weight, physical size, battery life, and USB port/no USB port. Examples of criteria for a vacation home include size, number of bedrooms, distance to beach, breakfast provided/breakfast not provided, and view/no view. Criteria may be objective and subject to precise measurement, such as weight (2.62 pounds), or subjective and only subject to rough measurement, such as comfort (moderately comfortable).

As used herein, a “feature” includes a feature, aspect, or attribute. Examples of features of a notebook computer system include 15.6 inch screen, DDR3 memory, 4 GB hard drive, and 6 hour battery life. In some cases, an item or offering may be characterized based on the presence or absence or a particular feature. For example, a computer may include the feature of an LCD display or the feature of a USB port. In some cases, a feature may be expressed in terms of a particular capacity or measure, such as a 10 GB hard drive, or minimum capacity or measure, such as a battery life of 10 hours or greater. In some cases, items or offerings may be evaluated in terms of similarity of features. For example, a notebook computer with a 9 hour battery life may be more similar to a notebook computer with a 10 hour battery life than a notebook computer with a 4 hour battery life. In some cases, features may be a combination of different existing criterion. For example, a notebook computer with a 5 hour battery life and a spare battery (that is included in the recommended offering) would have a combined 10 hour battery life and would be ranked higher than a notebook with only 8 hours of battery life and no additional accessory. In some cases, a user may choose to display a feature according to different dimensions. For example, a notebook with 8 hours of battery life can also be displayed and interpreted to the user in terms of how many domestic flights the computer can be utilized on before running out of power. This adapted feature would still be displayed under the criterion battery life and could also even depend on other known data about the user (such as how many flights the user takes on average in a given year).

As used herein, “offering” means a product, service, or benefit, or combination thereof, that can be offered to a prospective acquirer, such as a consumer or a business.

As used herein, “real-time”, in the context of performing a computation or updating a display, includes any computation or update that occurs while the user is engaged with the user interface. A real-time update may take perceptible amount of time to be completed, but would not involve a user having to, for example, switch to other activities while the update is completed.

As used herein, “tabular” means organized as a table or list in a systematic way. A tabular arrangement may include a table with row and columns. In certain embodiments, a tabular arrangement may be in the form of a listing (for example, an indented listing or numbered outline listing), such as:

1. honeycrisp
1a. $1.50/lb

2. red delicious
2a. $0.95/lb

As used herein, “tabulation” includes a set of elements that are arranged in a tabular form.

In various embodiments, a system and method generates real-time recommendations to users engaged in an information research and discovery task. A profile of each user may be generated based on information collected from his or her natural interactions with a comparison interface. Additionally, the system not only recommends items from its database but also recommends relevant features (unsponsored features, sponsored features, or both) to help guide the user's information retrieval task.

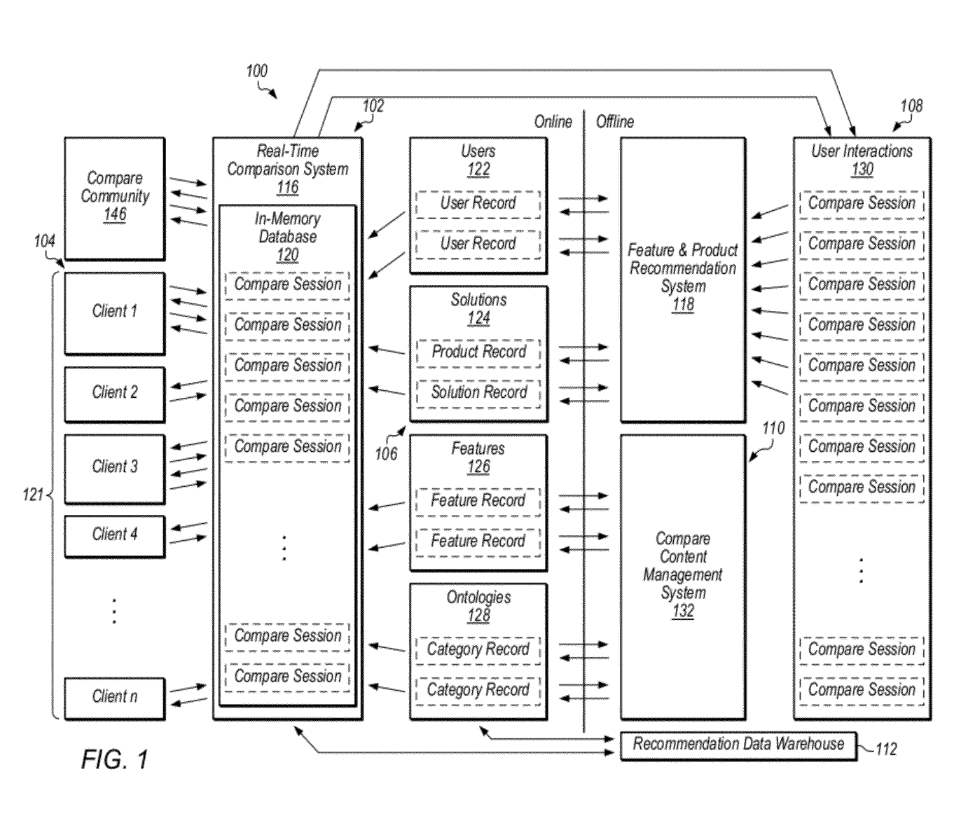

FIG. 1 is a block diagram illustrating one embodiment of a comparison system. In this example, aspects of the comparison system may be implemented as software modules. System 100 includes recommender module 102, client-side interface module 104, Product/solution database module 106, user/preference database module 108, product feature content management system 110, and recommendation data-warehouse 112. Each of the modules is described in further detail below.

1) Recommender module 102: This module may modify item recommendations in response to live user interaction and send updates to the client-side interface. In some embodiments, recommender module 102 provides recommendations in real-time. Recommender module 102 may generate new recommendation pages upon client request. In one embodiment, recommender module 102 is responsible for the following calculations:
a. Updating a extracted user-preference model
b. Recommending related features to further filter a comparison
c. Determining the top decision criteria for a user to consider per product
d. Generating personalized pricing promotions and other digital merchandising opportunities

Recommender module may include real-time comparison system 116 and feature and product recommendation system 118. Real-time comparison system 116 may include in-memory database 120. In-memory database may store information from compare sessions with clients.

In some embodiments, real-time comparison interactions take place across client at scale. Real-time comparison may include dumping interaction data periodically into an interaction database. In one embodiment, the interaction database is distributed, highly scalable data store that plugs into a recommender data warehouse. A real-time comparison system may in some cases handle millions of open connections, updating user comparison experiences. The system maybe optimized to handle simple event-driven interactions at scale, pushing data into in-memory key-value store for quick, low-latency data I/O. In certain embodiments, cloud-based hosting infrastructure may be leveraged to scale real-time connections and bandwidth.

2) Client-side interface module 104: This module may include all code that runs on the client's computer system. In addition to representing to comparison interface to clients 120, client-side interface module 104 may also include logic for dynamically updating the comparison interface from responses from the real-time recommender system running on a remote server. In one embodiment, hosted toolbar Javascript is cached and delivered via a CDN partner. CDN caching and infrastructure may provide variable scale on-demand for mixed use clients.

3) Product/solution database module 106: This module may store the data to be recommended to the user from the recommender module 102. Product/solution database 106 may serve product/solution data upon request from other modules in the system.

Product/solution database module 106 may include users module 122, solutions module 124, features module 126, and ontologies module 128. Each of the modules may store records that can be accessed by real-time comparison system 116 and feature recommendation module 118.

4) User/preference database module 108: This module stores anonymous user preferences generated by the user-preference extraction technique. User/preference database module 108 includes user interactions module 130. User/preference database module 108 may store information regarding interface actions and/or comparison sessions.

5) Product feature content management system 110: This module may process and store extracted features associated with generated comparison experiences. Product feature content management system 110 includes compare content management system 132. Features may be processed and collected from, for example, the following sources:
a. Automated text-based feature extraction using natural language processing techniques
b. Manual feature entry from a system administrator made available from the client-side interface
c. Manual feature entry from an end-user made available from the client-side interface
d. Automated from a product feed provided by or generated on behalf of a client

6) Recommendation data-warehouse 112: This module may perform intensive offline data processing to prepare the data in product/solution database module 106 to be accessed by real-time recommender module 102.

In some embodiments, feature/product recommendation system 118 parses user interaction logs, clustering users and pre-calculating recommendation. Compare content management system 132 may allow the update of features and new categories.

System 100 may include compare community module 146. Compare community module 146 may provide exchange of information relating to offerings and/or users that can be used to make recommendations. In one embodiment, compare community module 146 is a public community that exchanges information with a stand-alone, separate web application on virtual instances.

### Comparison Interaction

In some embodiments, item recommendations begin with offline processing performed by a recommendation data-warehouse, such as product data warehouse 112. Feature trade-offs may be calculated over all items in a specific category. An initial feature-to-feature trade-off matrix may be calculated by permuting through all combinations of items in a category and recording specific feature-to-feature distances in a ranked list of the features. One example of an algorithm to accomplish this is described below:

```
GenerateTradeOffMatrix(F, S, w)
    input:
        F - set of n comparable features
        S - set of m solutions
        w - a function f(s) = wₛ = ranking decay function
    P ← set of all permutations of S
    W = empty n × n preference matrix
    for each p ε P
        fSum = empty vector of size n
        for each s ε S
            for each f ε F
                fSum[f] += s * w(s)
        fMap = empty map of size n
        for each f ε F
            fMap[f].put(f, fSum[f])
        fMap.sort( )
        for f₁ ε F
            for f₂ ε F
                if(f₁ != f₂)
                    W[f₁, f₂] += fMap[f₁].pos − fMap[f₂].
```

The resulting trade-off matrix from this algorithm may be recorded in a product database for later use. Based on the results, a list of similar items may be generated for every product in the database. The list of similar items may be generated using a suitable similarity metric, such as cosine or Pearson correlation. The list may be generated and stored in each solution record in the database for later retrieval.

When a user requests a product comparison page from the client-side interface 104, a web request may be sent to a server running a real-time recommender module. Recommender module 102 may access both the pre-processed related products as well as the stored trade-off matrix. Recommender module 102 may dynamically generate the updated client-side comparison interface 104.

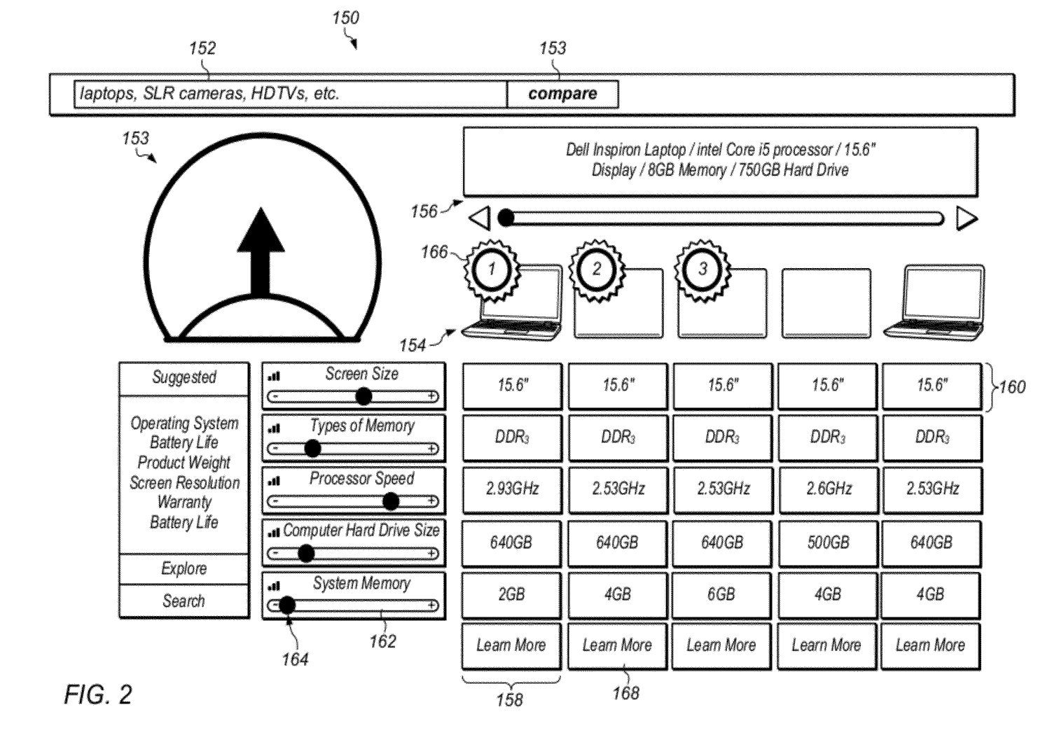

In one embodiment, a user is presented with the web-based or tablet comparison interface that includes a product-by-feature comparison matrix. FIG. 2 illustrates an example of a comparison matrix in one embodiment. Comparison display 150 includes search criteria box 152, user preference meter 153, and comparison matrix 154, and master control slider 156. Comparison matrix 154 includes columns 158 and rows 160. Each item is represented by one of columns 158 in this interface and each feature or criterion is represented by rows 160 of product data, spanning across all items in the matrix. Each feature also has a sliding interface 162 with slider 164 to allowing the user to modify the recommendations relative to that feature.

In some embodiments, a product comparison platform displays a product comparison table to a user and presents recommendations to the user (for example, ranking from left to right in the table). The product comparison table includes a comparison of two or more criteria for two or more products to be considered by the user. The criteria included in the product comparison table can be dynamically modified based on user input. Based on the user's input to one of the criteria, the platform may modify information presented for one or more other criteria in the product comparison table. The modification may be based, for example, on a modified weighting for one or more of the criteria for use in ranking the products being compared.

In some cases, adjusting a setting for one of the criteria in the table causes a modification of information for one or more other criteria (for example, modifying a color or shading for a product for one of the criteria). In some cases, moving the position of a slider on a bar for one criterion in the table affects one or more other criteria. For example, in a comparison of two or more notebook computer systems, moving the position of a slider on a bar for a Processor Speed criterion may affect a display of information for a System Memory criterion. In some cases, a ranking of products derived from two or more of the criteria is modified based on adjusting one of the criteria. In some cases, the strength of the resulting recommendation may be visually communicated to the user by updating the preference meter 153.

In certain embodiments, a product comparison platform can be extended across multiple mediums, including online, off-line and in-store. In some cases, in-store staff can access product comparison displays to see how in-store shoppers are comparing and discovering products in real-time.

In some embodiments, criteria displayed in a product comparison table are dynamically modified based on user input relating to one or more of the displayed criteria. Based on user input to one of the displayed criteria in a product comparison table, new criteria may be added to the product comparison table, displayed criterion may be removed from the product comparison table, or both. For example, in a comparison of two or more notebook computer systems, moving the position of a slider on a bar for a Graphics Processor criterion may cause a Screen Size criterion to be added to a product comparison table. In addition, a particular criterion may be moved to a higher or lower position in the product comparison table.

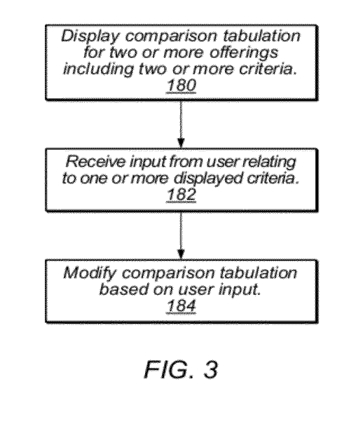

In some embodiments, a comparison tabulation is dynamically generated and displayed based on user input. User input for one criterion affects what is displayed in the comparison tabulation. The comparison tabulation may be, for example, a comparison matrix. FIG. 3 illustrates one embodiment of providing a comparison among offerings. At 180, tabulation (such as a comparison matrix) is displayed including two or more criteria for each of two or more offerings. The tabulation may include a recommendation for at least one of the offerings. In some embodiments, the offerings may be ranked (for example, from first to fourth). The offerings may be, for example, products or services. The tabulation may include a column for each of the offerings and a row for each of the criteria.

At 182, an input is received from a user relating to one of the criteria in the tabulation. The input may be, for example, a positioning of a slider for a bar associated with one of the criteria. For example, if the products being compared is a computer system, and one of the criteria in the comparison is screen size, the user may move the slider to the right to indicate that screen size is relatively important to the user. In some embodiments, the input from the user is quantitative. For example, positioning a slider at a certain location along a bar may provide a quantitative input (e.g., 6.71 on a scale from 1 to 10). In some embodiments, the user selects a specific preference before being presented a preference slider to interact with. For example, a user may indicate whether they care about Windows or OSX for their operating system criterion, at which point moving the slider to the right will weight the results by the user's specific explicit preference.

At 184, the tabulation is modified based on the input received from the user. The modification of the tabulation may include the tabulation with respect to at least one criterion other than the criterion that related to the user input. In some embodiments, a modification to the tabulation may include changing the position of a slider for one or more of the other criterion. In some embodiments, a modification to the tabulation includes adding a criterion or removing a criterion from the tabulation.

In some embodiments, a comparison system receives successive inputs from the user. The system may learn based on the user inputs. The modifications to the tabulation may be based on two or more of the user inputs.

In some embodiments, the ranking of offerings may change based on user input. For example, a particular offering may move up or down in the rankings based on the user input. In some cases, an offering may be added or removed from the tabulation based on the user input. For example, if a user indicates with a slider that processor speed is of high importance, notebook computer system with slower processors may be removed from the tabulation.

### User Preference Extraction

In order to customize the recommendations, the user must move the various feature sliders, indicating to the system a preference for items that exhibit more or less of that feature. As the user moves one slider, the rest of the visible feature sliders react in real time to the movement of the sliders. The movement of the sliders may exhibit trade-offs inherent in the user's choice that are relevant to the particular product category being explored.

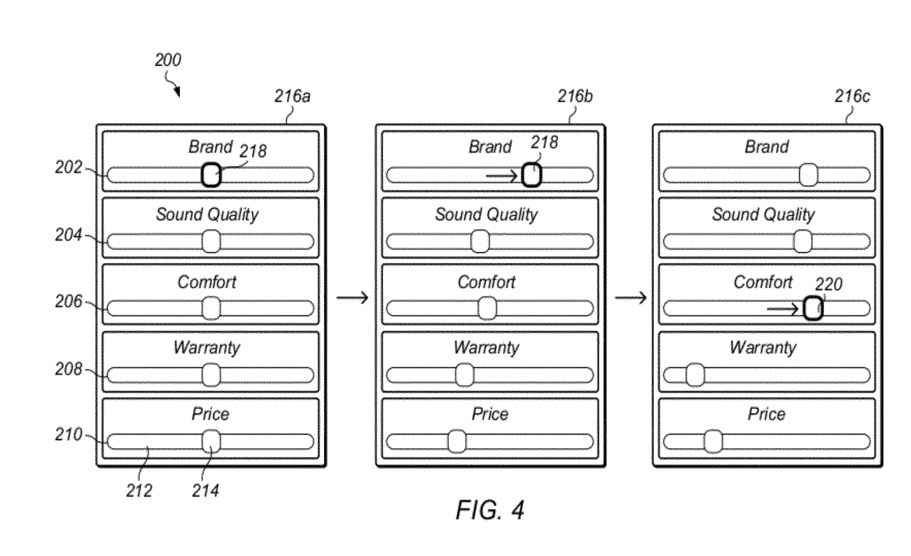

FIG. 4 shows an example of a set of sliders reacting to a user's input for features in a comparison matrix. Slider panel 200 includes brand slider 202, sound quality slider 204, comfort slider 206, warranty slider 208, and price slider 210. Each of the sliders includes bar 212 and slider tab 214. In this illustration, each of the slider tabs 214 starts out in the center in panel 216a. In panel 216b, slider tab 218 for brand slider 202 is moved by the user to the right. In response to the user's action, the system may automatically move others of the slider tabs. For example, increasing the value of the brand slider may cause the slider tab on the sound quality slider to move to the left. At 216c, the user may move slider tab 220 to the right, causing further changes in the positions of the various slider tabs. The movements in the slider tabs may provide an indication the user of the trade-offs among the various features of an offering.

Although in this example, sliders are moved left and right, user inputs may have other forms. For example, a slider may be vertically oriented and be moved up and down, or check box may be selected, or a numerical value may be entered into a box. For example, in some embodiments, a user may respond to guided questions. In some embodiments, a user may provide input by way of interactive visuals.

Although in this example, inputs may be expressed in terms of more or less of features, user inputs may have other attributes (for example, non-quantitative).

After each interaction with a slider, client-side interface 104 may send a new request to the real-time recommender module with the updated interaction. The real-time recommender may apply an algorithm to the sequence of feature interactions. In one embodiment, the algorithm is as described below.

In some embodiments, a system learns appropriate weights to apply to each feature in the interface update. In certain embodiments, the system may make specific slider movements slower than others, creating a visual weighted effect meant to indicate adaptation to the end user. An example of an equation for weighting features, utilizing a technique henceforth referred to as “feature-to-feature decay”, is set forth below.

$${S}_{F [ i ] F [ j ]}^{′} := {S}_{F [ i ] F [ j ]}^{′} + Δ {d}_{i} β {e}^{- \frac{\vert {C}_{ij} \vert}{k τ}} i , j = 1 , … , n$$

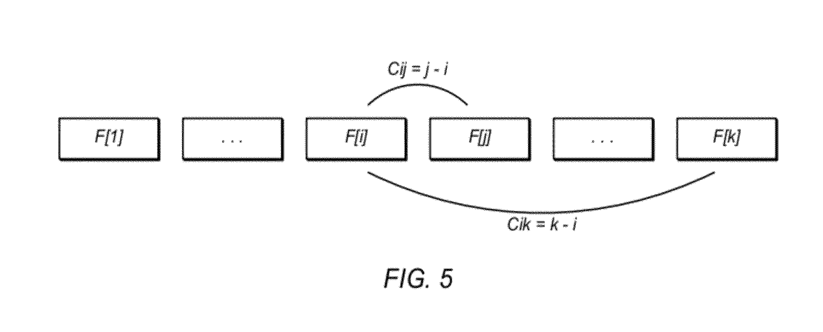

F_{[I]=i}^{th} feature interaction in the actionlist
F_{[J]=j}^{th} feature interaction in the actionlist
S′=raw user preference matrix meant to hold intermediary calculations
Δdᵢ=magnitude of slider movement at feature interaction i
Cᵢⱼ=distance between feature interaction i and j in actionlist
k=size of actionlist
T=learned constant
β=learned constant
   FIG. 5 is a visual representation of feature interactions that might serve as input for the above feature-to-feature decay algorithm, referred to as the “actionlist”. As the user corrects the weighted preference sliders, they generate a series of k actions, alternating between various features F₁, F₂, . . . , Fₙ for n features. In this example, features closest to each other within this actionlist are more strongly bound together (i.e.—users are less willing to make tradeoffs between features F[i] and F[j] when Cᵢⱼ is small relative to the total size k of the actionlist). Conceptually, this corresponds to users “reacting” more strongly to a feature that was modified, indicating an expressed desire to correct the value to a previously set value. The final weighed update algorithm makes use of an exponential decay function of the distance from feature to feature within the action list, giving weighted preference to closer features (outlined in the “feature-to-feature decay” algorithm above). In calculating the user preferences S, a raw preference matrix S′ is initialized with empty values zero and is filled by performing a double loop through the action list and updating the matrix values.

After this loop finishes, each row F[i] of S′ is normalized by calculating the row sum and dividing each row entry by this sum, where \textcircled{×}dᵢ is the magnitude of change with each slider interaction. This generates a probability mass distribution of a user's expressed preferences regarding each F[i]-F[j] relationship; however, one must note that this preference matrix is not, in itself, of the same nature as the trade-off matrix R used to adjust the slide interactions. The final preference matrix S is derived from the matrix calculation below. In the live system, the final preference matrix S is used to return an updated trade-off matrix P, causing the user to adjust their interaction and comparison.

Sᵢⱼ=RᵢⱼS′ᵢⱼ i,j=1, . . . , n

In some embodiments, updated slider movements may communicate to the end user the model that the system has learned thus far in the interaction. The weights may be selected to keep feature sliders in place after being set to a specific level by the end user. Moreover, the user interface may be designed to become more adaptive as the user engages with the tool further. The assigned weights and the recorded user's reaction to the weighting may be used to create a personalized trade-off matrix that is unique to the specific user's search task and preferences. This matrix may be further referred to as preference matrix P.

### Real-Time Feature Discovery

Generating real-time feature recommendations during the comparison process may include offline computation of a global correlative user mapping C_{G}. First, given a user u's preference matrix Pᵤ,

$${P}_{u} = [ \begin{matrix}{f}_{11} & {f}_{12} & … & {f}_{1 n} \\ {f}_{21} & {f}_{22} & … & {f}_{2 n} \\ ⋮ & ⋮ & ⋱ & ⋮ \\ {f}_{n 1} & {f}_{n 2} & … & {f}_{nn}\end{matrix} ]$$

where each cell fᵢⱼ contains the computed feature-to-feature trade-off of the i^{th} and j^{th} features. A raw master user preference matrix U may be created by flattening Pᵤ to create the user vector Uᵤ,

$${U}_{u} = [ \begin{matrix}{f}_{11} \\ {f}_{12} \\ ⋮ \\ {f}_{1 n} \\ {f}_{21} \\ {f}_{22} \\ ⋮ \\ {f}_{2 n} \\ ⋮ \\ {f}_{nn}\end{matrix} ] U = [ {U}_{{u}_{1}} {U}_{{u}_{2}} … {U}_{{u}_{m}} ]$$

for each of m users. U may be stored in a user preference database. The top k feature-to-feature trade-offs may be selected from U and a condensed user mapping matrix U^{k} may be generated by selected only those k rows from U.

C_{G} is defined over all m users,

$${C}_{G} = \frac{1}{n - 1} \cdot {U}_{k}^{T} {U}_{k}$$

Statistical techniques, such as Principal Component Analysis (“PCA”), may be applied to C_{G} to reduce its dimensionality. In the case of PCA, eigen-analysis may be applied to solve for matrices E and A such that,

C_{G}=E^{T} ΛE

and

EC_{G}E^{T}=Λ

Now, choosing only a subset of eigenvectors from E, the user data U can be mapped into a reduced dimensional feature space, allowing for more useful clustering of users. User clusters are generated using any number of existing unsupervised clustering algorithms in the literature, such as k-means clustering.

To generate a feature recommendation, a user's feature preference vector Fu may be mapped into the feature space and assigned a user class membership based on its location to other user clusters within that space (for example, nearest neighbor). The system then selects the highest ranked features from users within that cluster based on past interaction data.

### Generating Sponsored Features

Algorithms described above may provide a method of feature discovery based on past user behavior that allows users to choose top ranked features from similar-minded users. In some embodiments, features are selected and presented based on other metrics, such as propensity to purchase a particular item in a comparable feature set. In some embodiments, advertisers bid on profiles of users (defined by keywords, past purchases, specific feature trade-off profiles, etc.). Advertisers may bid competitively for placement within the feature discovery process. In this manner, a user may discover new decision criteria, as well as additional products.

In some embodiments, one or more of the criteria in a product comparison table, or features associated with criteria in a product comparison table, may be sponsored. Sponsorship of a particular criterion may allow the sponsor to promote its products by emphasizing criterion in which the sponsor's product is strong. For example, a manufacturer that sells notebooks with relatively fast processors may sponsor the Processor Speed criterion. As another example, a product manufacturer with a long battery life may emphasize a Battery Life criterion. In some cases, sponsoring a criterion causes the sponsored criterion to be added a product comparison table. In some cases, sponsoring a criterion causes the sponsored criterion to be moved up in a product comparison table. In some cases, a sponsored criterion is introduced as an additional criterion in a product comparison table in response to user input for one or more displayed criteria in the table. For example, if a user is selecting memory size and speed and high levels, the system may introduce a sponsored bar for Games Included. In some cases, upsale products are added to the comparison table based on user input, such as an extended warranty or a battery pack accessory.

In some embodiments, the action of sponsored criterion or features is used as the basis for a new ad unit in addition to, or in lieu of, a traditional search paradigm. Instead of bidding for placement within sponsored results, a comparison system may intelligently selects sponsored criterion or features that will drive users to visit pages within a site, database, store, or other commerce environment. The use of sponsored features may allow for better performing CPC advertising performance within the comparison information retrieval environment relative to traditional search systems.

In some embodiments, user profiles are used to target promotional offers or other forms of digital merchandising, such as real-time discounts, accessories, warranties, gift cards, and loyalty rewards. In certain embodiments, offers can also be used to generate traffic (for example, surfaced within the interface) based on the bidding activities of advertisers on the user preference profiles.

In some embodiments, a comparison system may be used in conjunction merchandising campaign. For example, a merchandiser may set campaign goals to move inventory. When an in-store sales representative talks to a customer, relevant features may be automatically shown in a comparison system on a mobile device. The comparison may be guided, for example, by global/regional marketing objectives.

In some cases, a client may choose to promote a particular brand through a comparison system. Based on the metrics selected by the retailer and implemented in the comparison system, the retailer may increase user consideration of a particular brand and/or sales of the particular brand. In some embodiments, a manufacturer may fund a promotion (for example, instead of a client retailer). This funding can come in the form of performance-based advertising fees (i.e.—cost-per-click, cost-per-mille impressions, etc.), an increase in the market development funds the manufacturer currently pays the client retailer, or in lieu of price discounting or inventory buybacks.

### Real-Time Product Recommendation

In some embodiments, a preference matrix P is used to match the active user to other past users in the database using a similarity metric, such as the Pearson product-moment coefficient. For example, during a live interaction, as client-side interface 104 continues to update recommender module, recommender module 104 may use a preference matrix P to dynamically modify the product recommendations by adjusting the weights of individual user weights in an item-to-item based collaborative filtering algorithm. In some embodiments, recommender module 104 updates the recommendations in real-time.

As new feature interactions are sent and the user model is updated, the list of comparable items may be re-ranked. In one embodiment, a list of comparable items may be re-ranked based on the following formula:

$${P}_{rank} ( i ) = {F}_{filter} ( i ) \cdot {P}_{rank} \{ \begin{matrix}S ( {U}_{1} ) ( i ) \\ S ( {U}_{2} ) ( i ) \\ ⋮ \\ S ( {U}_{n} ) ( i )\end{matrix} \}$$

where the new rank of the ith item (Pᵣₐₙₖ(i)) is a function of the given feature filter constraints (F_{filter}(i)) and the product ranking function (Pᵣₐₙₖ(U)), where U is the modified user vector. IN this example, the user vector is made up of the n similarity values of Uⱼ to the active user for each of j users in the ranking algorithm. The vector Uⱼ is selected from the master user preference matrix U.

In some embodiments, ranking of products is based on macro learned values. An offline process for learning comparative values may include mining, training from interaction data, or combinations thereof. Real-time updating may be based on inputs from an end user.

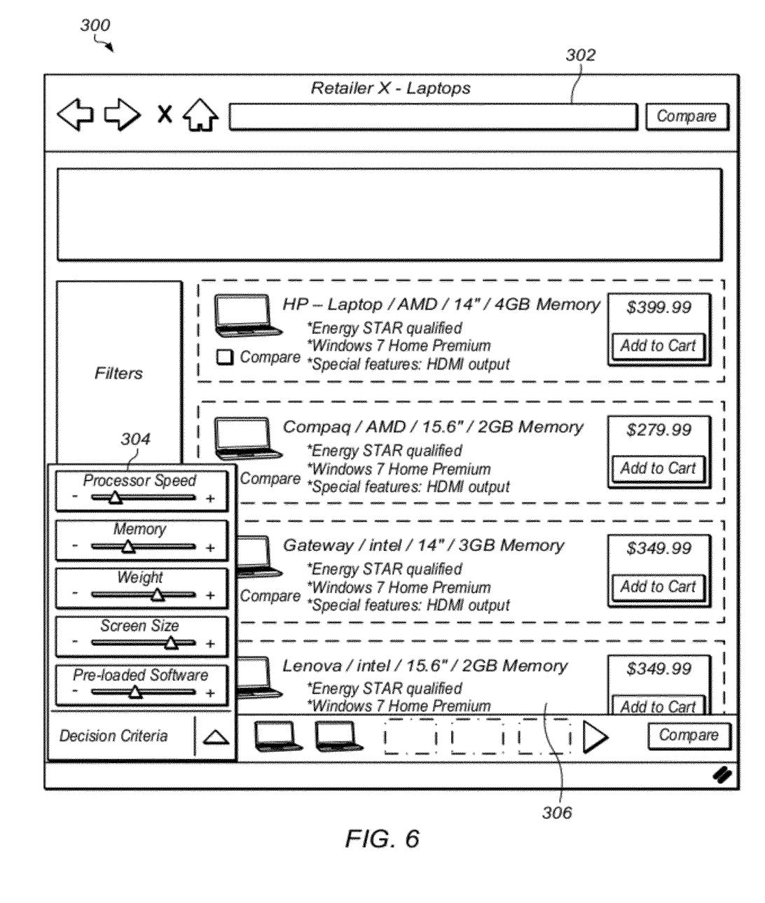

FIG. 6 illustrates an embodiment of the described comparison and feature discovery system utilized as an extension of an existing category results page. Enhanced category page interface 300 includes search bar 302, criterion controls 304, and product listing 306. In some embodiments, manual feature entry is carried out from a system administrator using the client-side interface. In some embodiments, manual feature entry is made from an end-user made available using the client-side interface. In either embodiment, a user's interactions with criterion controls 304 will manipulate the resulting ordering of product listing 306.

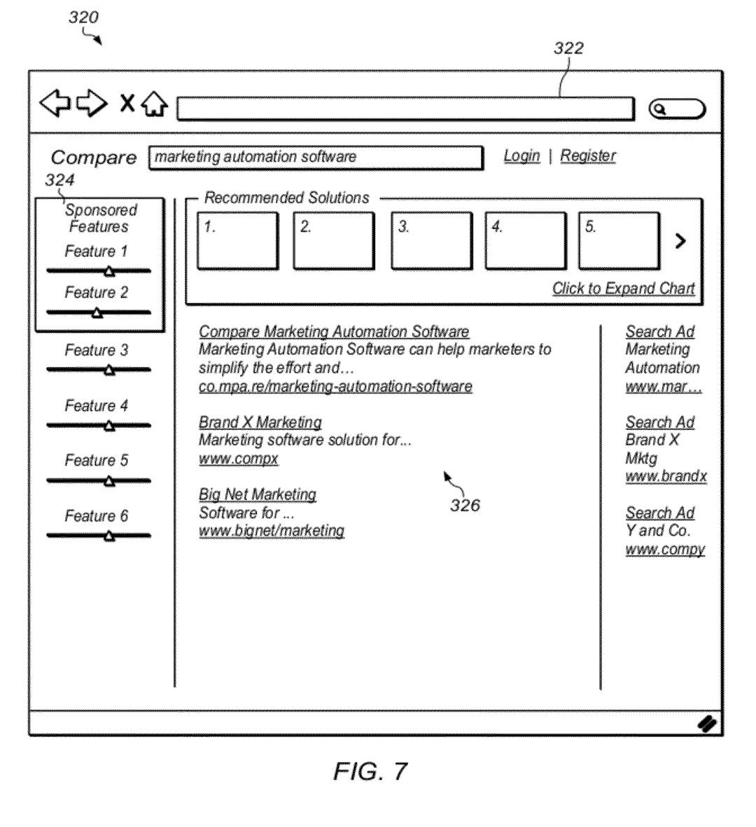

FIG. 7 illustrates a visual demonstration of the use of feature discovery to enhance natural language search. Enhanced natural language search interface 320 includes search bar 322, feature controls 324, and offering listing 326. Changes in feature controls 324 may result in changes in offering listing 326.

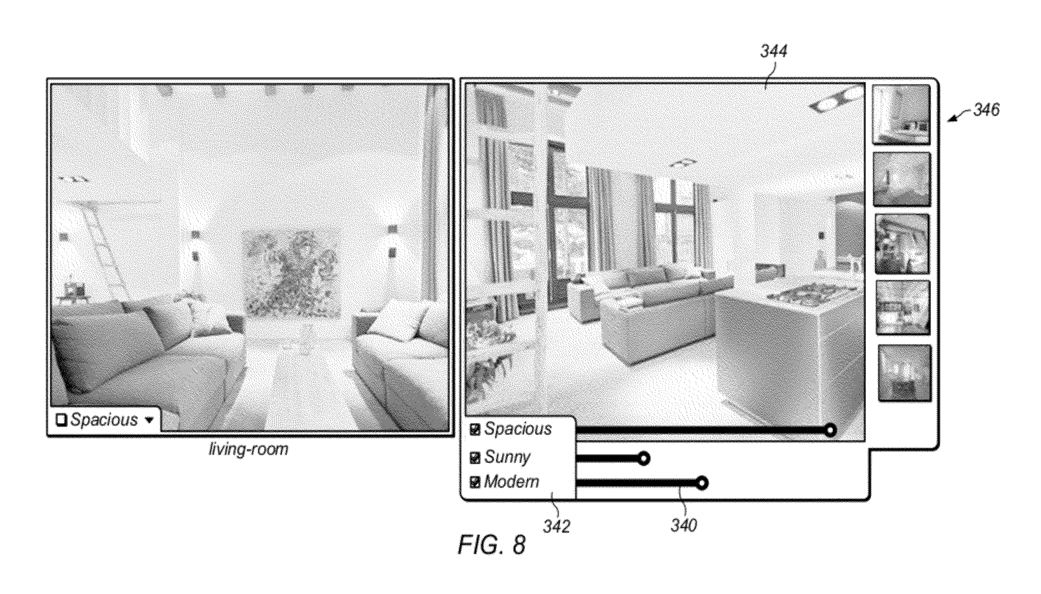

FIG. 8 illustrates one embodiment of a comparison interface with images. Criterion indicators 340 and user input prompts 342 may be superimposed on or next to each of images 344. Resulting offering listing 346 may be superimposed on or next to each of images 344. In some embodiments, user input prompts 342 are meant to refer to the particular feature represented within the image. For example, a picture of a large, spacious living room may possess the criterion of “spacious”. The criterion is indicated by the text “spacious” that is directly superimposed on or next to the image. Changes in criterion indicators 340 will adjust a user's preferences and may result in changes in offering listing 346.

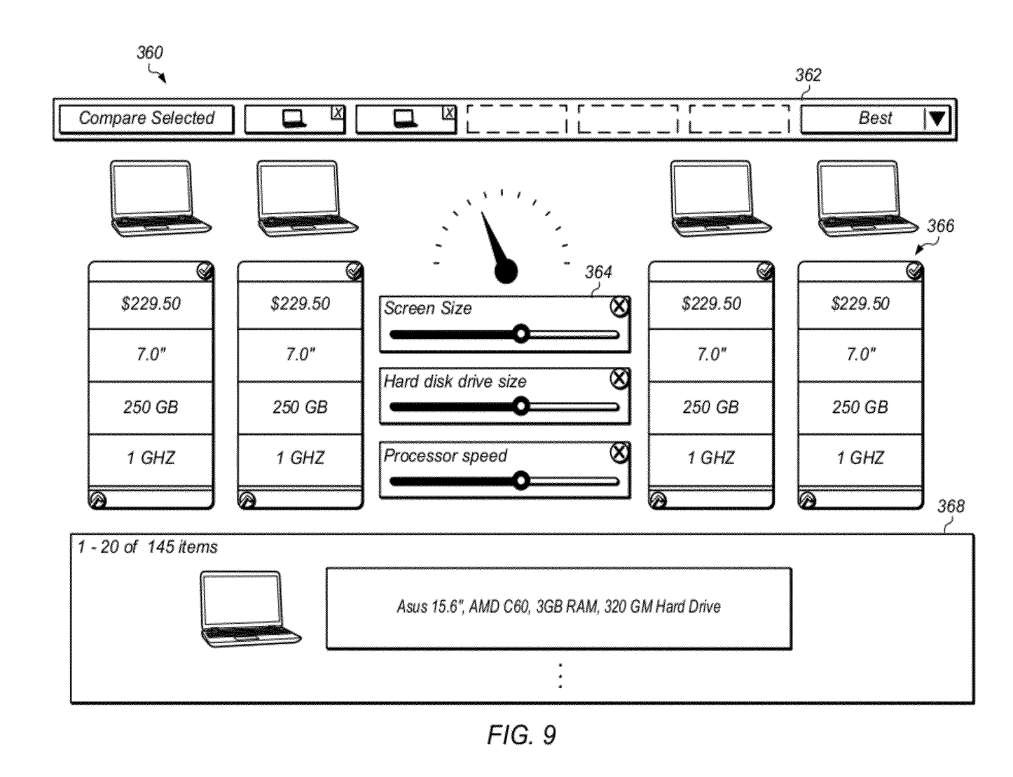

In some embodiments, a platform includes personalized landing pages targeted towards consumers who are looking to compare commerce items. In one embodiment, a client uses a server-side SDK to create a comparison page that can be indexed by search engine. FIG. 9 illustrates an embodiment of a comparison landing page. Comparison landing page 360 includes comparison selection bar 362, criterion controls 364, product table 366, and product listing 368.

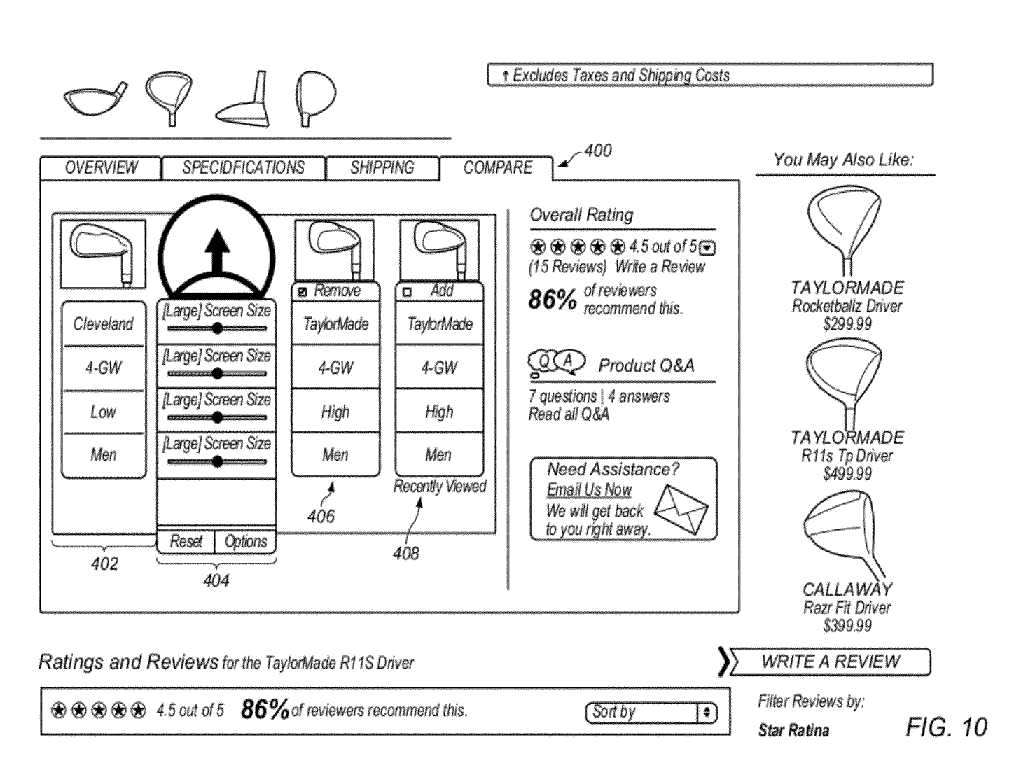

In some embodiments, a compare interface may be embedded directly on product display pages within online retail environments. FIG. 10 illustrates an embodiment of a product page enhanced with the product comparison and feature discovery platform. The comparison and feature discovery application 400 is embedded directly on the product display page and includes highlighted features for that particular product 402, the preference meter and feature interaction tool 404, previously selected products 406, recently viewed products 408 from an online browsing session.

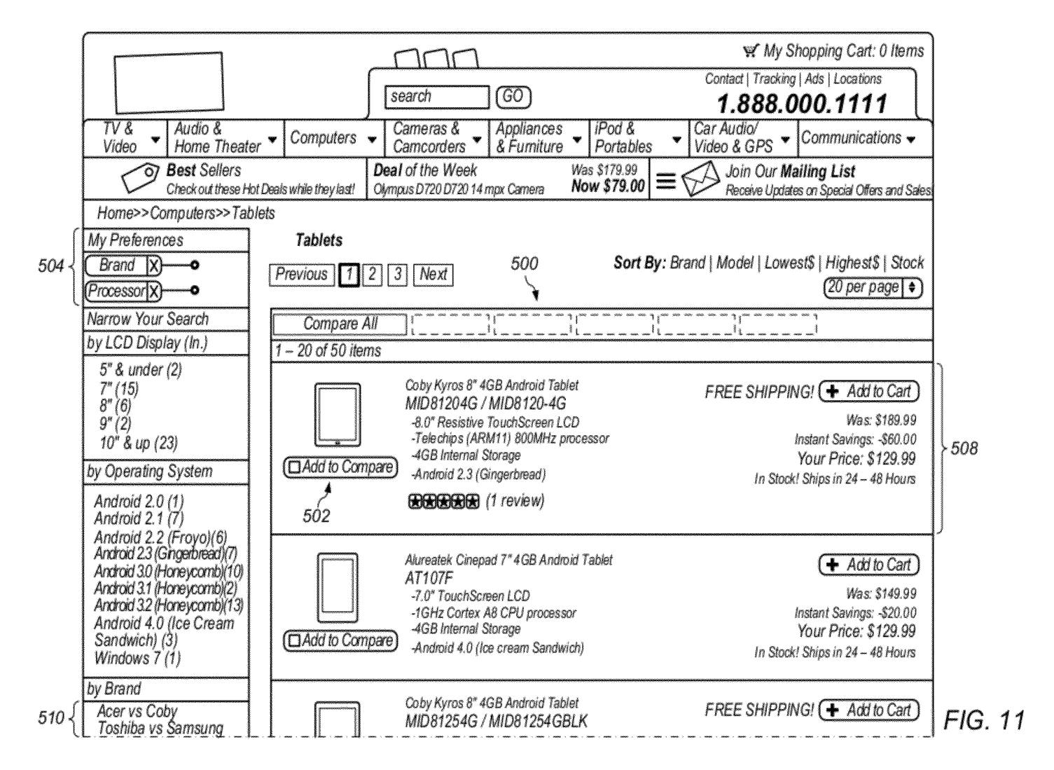

In some embodiments, various comparison and feature discovery tools may be embedded directly on category pages within online retail environments. FIG. 11 illustrates an embodiment of a category page enhanced with the product comparison and feature discovery platform. The category page includes an embedded compare toolbar 500 to keep track of compared products, injected compare buttons 502 to add products to a selection, a selected preferences section 504 that provides criterion controls 506 that manipulate the ranked commerce offerings 508. The platform also enhances the existing search filters with quick versus selections 510 that allow users to load up the compare interface on a subset of a specific criterion.

In one embodiment, a “Send to Phone” widget allows a retailer, online browser, or researcher to wirelessly beam existing compared items to a mobile phone. The system may provide assistance in routing the user to the nearest store with relevant items. In-store, to mobile comparison experience may be enabled (for example, through a smart phone) that allows a consumer to compare and contrast product that the consumer physically interacts with at the store. In some embodiments, a retailer's in-store staff accesses a computer (for example, by way of a tablet) that provides information on how in-store shoppers are comparing and discovering products in real-time. In addition, reporting and analytics can be generated from the comparison system (for example, to gather intelligences such as in-store performance.)

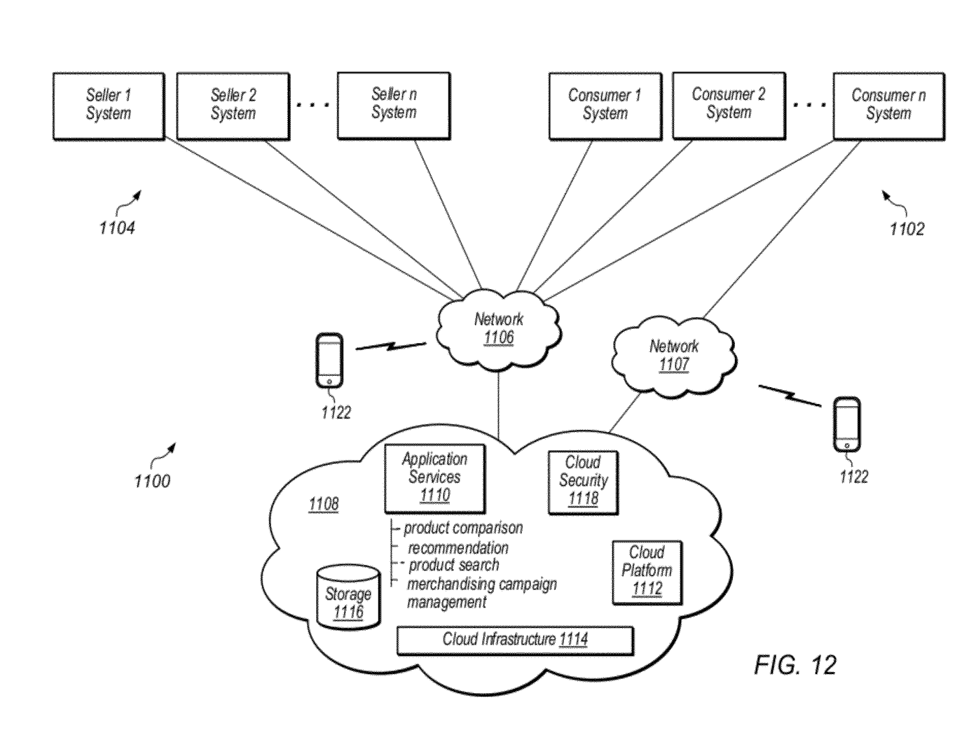

In some embodiments, services, such as product comparison, shopping, or business intelligence services, are provided by way of a cloud computing system over a communications network. FIG. 12 illustrates one embodiment of a cloud computing system that can be implemented to provide services to consumers or sellers.

System 1100 includes computing systems 1102 accessed by consumers 1 through consumer n. Consumer computing systems 1102 may include, for example, a network of computing devices distributed at retailer sites and connected to network 1106. Each of computing systems 1102 may be connected to cloud computing system 1108 by way of network 1106. In certain embodiments, consumer computing systems 1102 may be connected to one another by way of network 1106.

Cloud computing system 1108 may provide remote computing resources, remote storage resources, or both, for systems connected to cloud computing systems 1108. For example, cloud computing system 1108 may provide cloud computing services to users of consumer computer systems 1102 and seller systems 1104. Sellers may be, for example, manufacturers, retailers, distributors, or merchants.

Various system architectures may be employed in cloud computing system 1108. Systems and components of cloud computing system 1108 may be at a single physical location, such as a data center, or distributed among any number of locations. Cloud computing system 1108 includes cloud application services 1110, cloud platform 1112, cloud infrastructure 1114, cloud data storage 1116, and cloud security 1118. Cloud applications services may be implemented by way of one or more computer systems, each include one or more central processing units, such as described herein. Examples of application services 1110 include providing product comparison or online purchasing services. Cloud application services 1110 may access cloud data storage 1116.

In some embodiments, product comparison, online purchasing, retail management, other services to consumers or merchants are managed using application services in a computing cloud. In one embodiment, product search, business intelligence, or combinations thereof, are performed as one of application services 1110. In certain embodiments, services in a cloud receive a message feed from a local computing system, such as one or more of seller computing systems 1104, or from third party information providers.

Cloud infrastructure 1114 may encompass a variety of physical resources, such as computing devices, servers, block storage, mass storage devices, file servers, software, and network systems. In some embodiments, a cloud computing system encompasses virtualized resources, such as virtualized data storage or virtualized hardware.

In some embodiments, a service provider provides services to retailers and manufacturers by way of cloud computing resources. In some embodiments, computation resources are rented or leased to customers of the service provider. In certain embodiments, services are provided to users at sites as software as a service (“SaaS”) or platform as a service (“Paas”). Services may be provided to each user on an on-demand basis.

Networks 1106 and 1107 may include any suitable data network or combination of networks that enable the exchange of information between electronic systems. For example, networks 1106 may include one or more Local Area Networks (LANs) such as Ethernet networks, as well as Wide Area Networks (WANs), Metropolitan Area Networks (MANs), or other data or telecommunication networks implemented over any suitable medium, such as electrical or optical cable, or via any suitable wireless standard such as IEEE 802.11 (“Wi-Fi”), IEEE 802.16 (“WiMax”), etc. In various embodiments, all or a portion of networks 1106 may include the network infrastructure commonly referred to as the Internet. In other embodiments, networks 1106 and 1107 may be entirely contained within an enterprise and not directly accessible from the Internet. In certain embodiments, information may be exchanged over a virtual private network. In one embodiment, information is exchanged over the internet, but encrypted in such a way to make a private network not accessible from the rest of the internet.

In various embodiments, some users may be connected over a different network than other users. For example, as shown in FIG. 12, a consumer may be connected to cloud computing system 1108 over network 1107. In some embodiments, one or more users are connected over a private network. For example, in the embodiment shown in FIG. 3, network 1106 may be a public network and network 1107 may be a private network.

In various embodiments, a user may communicate over systems in system 1100 from locations external to retailers and cloud computing system 1108. For example, a consumer may be in a retail store may communicate with users at a remote location by way of portable electronic devices 1122. Portable electronic devices 1122 may be located anywhere, including a home, a retail store, or any other location.

Although for illustrative purposes only three consumers and three retailers are shown in FIG. 12, a system may include any number of sites and any number of site computer systems. In some embodiments, one retailer has two or more retailer computer systems.

Computer systems may, in various embodiments, include components such as a CPU with an associated memory medium such as Compact Disc Read-Only Memory (CD-ROM). The memory medium may store program instructions for computer programs. The program instructions may be executable by the CPU. Computer systems may further include a display device such as monitor, an alphanumeric input device such as keyboard, and a directional input device such as mouse. Computer systems may be operable to execute the computer programs to implement computer-implemented systems and methods.

A computer system may allow access to users by way of any browser or operating system.

Computer systems may include a memory medium on which computer programs according to various embodiments may be stored. The term “memory medium” is intended to include an installation medium, e.g., Compact Disc Read Only Memories (CD-ROMs), a computer system memory such as Dynamic Random Access Memory (DRAM), Static Random Access Memory (SRAM), Extended Data Out Random Access Memory (EDO RAM), Double Data Rate Random Access Memory (DDR RAM), Rambus Random Access Memory (RAM), etc., or a non-volatile memory such as a magnetic media, e.g., a hard drive or optical storage. The memory medium may also include other types of memory or combinations thereof. In addition, the memory medium may be located in a first computer, which executes the programs or may be located in a second different computer, which connects to the first computer over a network. In the latter instance, the second computer may provide the program instructions to the first computer for execution. A computer system may take various forms such as a personal computer system, mainframe computer system, workstation, network appliance, Internet appliance, personal digital assistant (“PDA”), television system or other device. In general, the term “computer system” may refer to any device having a processor that executes instructions from a memory medium.

The memory medium may store a software program or programs operable to implement embodiments as described herein. The software program(s) may be implemented in various ways, including, but not limited to, procedure-based techniques, component-based techniques, and/or object-oriented techniques, among others. For example, the software programs may be implemented using ActiveX controls, C++ objects, JavaBeans, Microsoft Foundation Classes (MFC), browser-based applications (e.g., Java applets), traditional programs, or other technologies or methodologies, as desired. A CPU executing code and data from the memory medium may include a means for creating and executing the software program or programs according to the embodiments described herein.

Various embodiments may also include receiving or storing instructions and/or data implemented in accordance with the foregoing description upon a carrier medium. Suitable carrier media may include storage media or memory media such as magnetic or optical media, e.g., disk or CD-ROM, as well as signals such as electrical, electromagnetic, or digital signals, may be conveyed via a communication medium such as a network and/or a wireless link.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Methods may be implemented manually, in software, in hardware, or a combination thereof. The order of any method may be changed, and various elements may be added, reordered, combined, omitted, modified, etc. Changes may be made in the elements described herein without departing from the spirit and scope of the invention as described in the following claims.

1. A method of providing a comparison among two or more offerings, comprising:
displaying a tabulation of two or more criteria for two or more offerings;
receiving an input from a user relating to a first one of the criteria in the tabulation; and
automatically modifying, by a computer system, based on the input received from the user for the first one of the criteria, the tabulation with respect to at least one criterion other than the first one of the criteria.

2. The method of claim 1, wherein the tabulation comprises a recommendation of at least one offering to the user.

3. The method of claim 1, wherein the tabulation comprises a table comprising two or more columns and two or more rows, wherein each of at least two of the columns corresponds to particular offering, wherein each of at least two of the rows corresponds to a particular criterion.

4. The method of claim 1, wherein the input from the user comprises a quantitative input.

5. The method of claim 1, wherein the input from the user comprises receiving an input for positioning a slider associated with the first one of the criteria.

6. The method of claim 1, wherein at least one of the criteria in the tabulation is displayed based on sponsorship of the criterion or a feature associated with the criterion.

7. The method of claim 1, wherein the tabulation includes two or more offerings selected by a user from the results of a search query.

8. The method of claim 1, wherein the tabulation includes two or more offerings selected by a user from the results of a category listing page.

9. The method of claim 1, wherein the tabulation includes two or more offerings selected by a user from within an existing product details page.

10. The method of claim 1, wherein modifying the tabulation comprises modifying one more filters for the criteria in the tabulation based on the input from the user for the first one of the criteria in the tabulation.

11. The method of claim 1, wherein modifying the tabulation comprises changing other criteria in the tabulation based on the input from the user for the first one of the criteria in the tabulation.

12. The method of claim 1, wherein modifying the tabulation comprises adding a criterion to the tabulation based on the input from the user for the first one of the criteria in the tabulation.

13. The method of claim 1, wherein modifying the tabulation comprises removing a criterion to the tabulation based on the input from the user for the first one of the criteria in the tabulation.

14. The method of claim 1, wherein modifying the tabulation comprises modifying a weighting of at least one other displayed criterion based on the input from the user for the first one of the criteria in the tabulation.

15. The method of claim 1, wherein modifying the tabulation comprises changing the order of at least one of the other criterion in the tabulation based on the input from the user for the first one of the criteria in the tabulation.

16. The method of claim 1, wherein receiving the input from the user comprises receiving an input for positioning a slider on a bar associated with the first one of the criteria, wherein modifying the tabulation comprises modifying the position of slider associated with at least one other displayed criterion.

17. The method of claim 1, further comprising, after modifying the tabulation based on the input from the user for the first one of the criteria in the tabulation:
receiving at least one additional input from the user for one of the criteria in the tabulation; and
modifying the tabulation based at least in part on the additional input from the user.

18. The method of claim 1, wherein modifying the tabulation comprises changing at least one ranking or order of offerings in the tabulation based on the input from the user for the first one of the criteria in the tabulation.

19. The method of claim 1, wherein modifying the tabulation visually updates meter or scale to represent the accuracy of the given recommendation based on what is known about the user's preferences from successive inputs.

20. The method of claim 1, wherein modifying the tabulation comprises adding an offering to the tabulation based on the input from the user for the first one of the criteria in the tabulation.

21. The method of claim 1, wherein modifying the tabulation comprises removing an offering from the tabulation based on the input from the user for the first one of the criteria in the tabulation,
receiving an input from a user relating to a first one of the criteria in the tabulation; and
modifying, based on the input received from the user for the first one of the criteria, the tabulation with respect to at least one criterion other than the first one of the criteria.

22. The method of claim 1, wherein the two or more offerings are products available to the user.

23. The method of claim 1, wherein the two or more offerings are services available to the user.

24. The method of claim 1, wherein the two or more offerings are combinations of other offerings available to the user.

25. The method of claim 1, wherein the tabulation comprises one or more images for each of at least one of the two or more offerings.

26. The method of claim 25, further comprising displaying a prompt for user input relating to at least one of the criteria on at least one of the images.

27. The method of claim 1, further comprising displaying, in response to the user input, one or more links to at least one web page comprising information about at least one of the displayed offerings.

28. A system, comprising:
a processor;
a memory coupled to the processor, wherein the memory comprises program instructions executable by the processor to implement:
displaying a tabulation of two or more criteria for two or more offerings;
receiving an input from a user relating to a first one of the criteria in the tabulation;
and
modifying, based on the input received from the user for the first one of the criteria, the tabulation with respect to at least one criterion other than the first one of the criteria.

29. A non-transitory, computer-readable storage medium comprising program instructions stored thereon, wherein the program instructions are configured to implement:
displaying a tabulation of two or more criteria for two or more offerings;
receiving an input from a user relating to a first one of the criteria in the tabulation; and
modifying, based on the input received from the user for the first one of the criteria, the tabulation with respect to at least one criterion other than the first one of the criteria.

30. A method of providing a comparison among two or more offerings, comprising:
displaying a tabulation of two or more criteria for two or more offerings;
receiving an input from a user for one or more of the criteria in the tabulation;
determining one or more preferences of the user based on the input from the user; and
automatically modifying, by a computer system, the tabulation based on at least one of the determined preferences of the user.

31-51. (canceled)

52. A method of providing a comparison among two or more offerings, comprising:
automatically generating, by a computer system, a tabulation of two or more criteria for two or more offerings;
displaying the tabulation of the two or more criteria to a user, wherein at least one of the criteria in the tabulation is included based on sponsorship of the criterion or a feature associated with the criterion.

53-65. (canceled)

66. A method of providing a recommendation, comprising:
displaying an initial recommendation to a user, wherein the recommendation comprises one or more criteria;
receiving an input from a user relating to at least one of the criteria; and
automatically updating, by a computer system, the displayed recommendation based on a user preference model for the user, wherein the user preference model is based at least in part on the input received from the user after the initial recommendation is displayed to the user.

67-76. (canceled)
